(19) United States
(12) Patent Application Publication
(10) Pub. No.: US 2006/0245742 A1
(43) Pub. Date: Nov. 2, 2006

(54) Dvd player enhancement

(75) Inventors: Alexis S.R. Ashley, Redhill (GB); Immo Benjes, Redhill (GB); Jonathan C. Foster, Bradford-On-Avon (GB); Richard J. Houldsworth, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/556,473

(22) PCT Filed: May 10, 2004
(86) PCT No.: PCT/IB04/01563

§ 371 Date: Nov. 10, 2005

(30) Foreign Application Priority Data
May 15, 2003 (GB) 0311141.6

(51) Int. Cl. H04N 5/00

(52) U.S. Cl. 386/126

(57) ABSTRACT

An extended DVD system includes a DVD player 2 capable of playing disks 6 with extended application capabilities. On inserting a disk, a DVD video virtual machine (VM) 20 is started from a platform-independent execution environment (18), which reads the video content from the disk and provides an audiovisual display based on that content. The DVD video VM 20 determines when specified events occur and calls back to the platform-independent execution environment 18, which causes commands to be executed such as a separate application stored on the DVD disk 6.

The invention relates to a DVD player and a method of operating a DVD player, and in particular a method of operating a DVD with enhanced functionality.

Conventional digital versatile disks (DVDs) may include a number of different types of data. In particular, DVD video (DVD-V) data may be stored in a universal data format (UDF) file. DVD video data is stored in a standard format on the disk, with a large number of video object units making up cells, which are in turn grouped together as one or more titles on a DVD-V disk. Further details will not be provided here, since the format is well known to those skilled in the art.

DVD video data may be played on a conventional stand-alone DVD video player. DVD video content is largely audiovisual, but DVD video also includes the possibility of limited interactive menus which allow the user to navigate the content of the DVD. The instructions are executed on a virtual machine (VM) implemented on the DVD player. The instructions available within the DVD VM are however relatively restricted and it is not possible to create complex applications with these instructions.

DVD disks can also store data in formats other than DVD video. In particular, DVD disks are widely used for storing files for computer systems in an ISO/UDF format. These files can include any file that may be stored on a computer system. Thus, a DVD may include executables stored in an ISO/UDF file system on the DVD. These executables may be read by apparatus, in particular a computer with a DVD reader. When read by the computer, the executables can be run on that computer.

Another standard is the Multimedia Home Platform (MHP), which is directed at broadcast material. In this standard, already introduced in several countries around the world, sophisticated applications written in Java code may be broadcast together with audiovisual content. An Application Information Table is broadcast to signal MHP applications. However, this standard does not address the issue of stored content such as DVDs.

US2002/0141741 to Zou et al sketches a way of implementing applications on disks such as DVDs. An autorun playback program is stored on the disk and is automatically launched when the disk is inserted into a player. The autorun playback program automatically launches and is thereafter used to access and play back the media content. By providing such a program on the disk itself, copy protection is expedited since copyright protection software can be integrated into the program. The player also includes a conventional DVD VM for playing conventional DVD disks which do not store a playback program on the DVD. This document does not describe a backwards compatible DVD disk that will provide additional functionality in an enhanced player but still provides conventional DVD playback functionality in a conventional player. In view of the focus in US2002/0141741 on copyright protection, the lack of ability to play back enhanced DVDs on a conventional player may well have been considered desirable.

However, in view of the large number of existing installed DVD players, content providers are likely to want to supply DVD video disks which play back on existing players as well as offering enhanced functionality on enhanced players.

There thus remains a need for an enhancement to standard DVD-Vs and playback methods and apparatus to allow more sophisticated applications to be delivered on a DVD in such a way that the applications are integrated into the conventional DVD video content in a backwards compatible manner.

According to the invention, there is provided a method of displaying audiovisual content stored on a disk including DVD-video content and non-DVD video application content, including the steps of: running an external application; starting a DVD video virtual machine (VM) for reproducing DVD-video content including audiovisual content and DVD-video menus; in the DVD video VM, reading the DVD video content from the disk and providing an audiovisual display based on that content; determining when specified events occur in the DVD video VM and calling back from the DVD video VM to the external application when one or more of the specified events occur; and executing application commands triggered by the event that has occurred.

The application triggered by the events may be simply the initially started external application. Alternatively, the application may be a separate application started either directly by the DVD VM or by another application such as the external application.

Preferably, a platform independent execution environment is started, and the external application run in that environment.

Importantly, the DVD VM is used to interpret the audiovisual content stored as conventional DVD-V content. Thus, the DVD-VM should be able to fully process DVD-video, including both audiovisual content and menus. The enhanced functionality is provided in the platform-independent execution environment when the specified events occur.

By using a largely conventional DVD VM to display the standard audiovisual content it is much easier to ensure the compatibility of an enhanced disk with conventional players. A conventional player will simply interpret the DVD-video as normal. The conventional player will in general simply run its conventional DVD VM. Although the conventional DVD VM will not be able to register events, to call back a calling routine when the events occur, or to allow manipulation of data structures, it will simply play back the DVD-V data as conventional DVD-V without the enhanced functionality.

The DVD-VM may conveniently be written in the platform-independent execution environment.

It is particularly preferred that the platform independent execution environment is autostarted on insertion of the DVD into a player. There are a number of ways of achieving this.

In one approach, the disk contains a Java archive file (jar file) with a standard name, for example start.jar, including all classes and resources in the ISO/UDF file system of the DVD. This file contains the standard manifest.mf file which includes the location of the autostart application and its starting parameters.

In an alternative approach, an additional elementary stream is included on the disk with a stream type of 0x06 (private data) or in the range 0x80 to 0xFF (user data). This additional elementary stream includes the content of a Java archive file packed in packetized elementary stream (PES) packets. The first packet contains the application information table (AIT) data.

The boot loader of a disk player identifies the additional elementary stream and checks whether the first PES packet contains an AIT. If so, a jar file is built from the PES packets of the additional elementary stream and the application specified in the AIT is started.

Normal disk players simply ignore the private elementary stream.

Preferably, communication between the DVD VM and the external platform-independent application is provided through an application programming interface (API). Accordingly, unlike in conventional DVD playback systems, the DVD VM in preferred embodiments includes an API for control by the external application which implements the functions of calling the API from the platform-independent execution environment to register the specified events with the API, and calling back from the VM to the platform-independent execution environment when the registered specified events occur.

Note that conventional DVD playback systems have media control APIs to start the DVD, pause and rewind. However, these APIs cover only the conventional operation controls of a DVD player; the DVD VM is not exposed and so inaccessible, and there is no possibility of accessing inner processing of the DVD VM.

In preferred implementations the DVD VM API allows the external application to call the API to manipulate VM data structures, for example menus. This allows the external application to provide different menu options as required, for example after one of the specified events has occurred.

After the external application has dealt with the event, it may return processing to the DVD VM to play more audiovisual content or to display an updated menu and wait for user input.

The external application may carry out any processing required when control returns to the external application after an event. For example, the external application may allow the user to play a suitable video game, and depending on the result of the game the external application may cause the DVD VM to display different subsequent audiovisual content.

The DVD preferably includes MPEG stream descriptors, and the method includes the step of recognising the MPEG stream descriptors, for example to synchronise the external application with events in the video.

The external application for the platform-independent execution environment is preferably in platform-independent code such as Java, MHEG, OpenTV, MediaHighway, or a combination of these. This avoids the problems of conventional DVDs storing applications in the ISO or UDF file systems which can only execute on suitable computers.

The invention also relates to code for causing a DVD player to carry out a method as set out above.

In another aspect, the invention also relates to a DVD player for playing DVD disks using the method as set out above. Accordingly, the invention also relates to a DVD player comprising:

code implementing a DVD virtual machine (VM) for displaying DVD-video data, the DVD virtual machine further including an application programming interface (API) containing code whereby external applications can call the API to start or stop execution of the DVD VM, to register specified events, and to call a calling application back when specified events occur;

an autostart system for automatically running an external application stored on an inserted DVD disk, if the external application is present, so that the external application calls the DVD VM API to play back content on the DVD.

A preferred embodiment of the invention will now be described, purely by way of example, with reference to the accompanying drawings, in which:

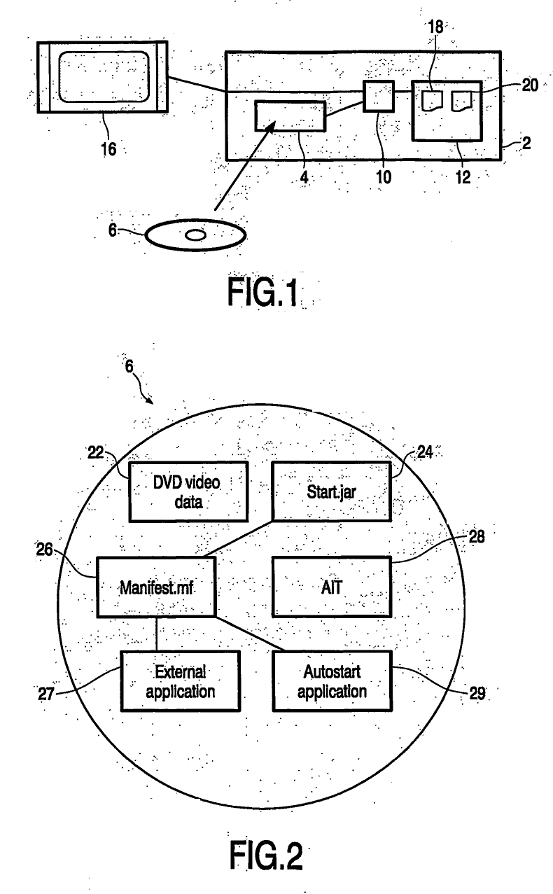

FIG. 1 shows a DVD player according to the invention;

FIG. 2 shows a representation of a disk according to the invention; and

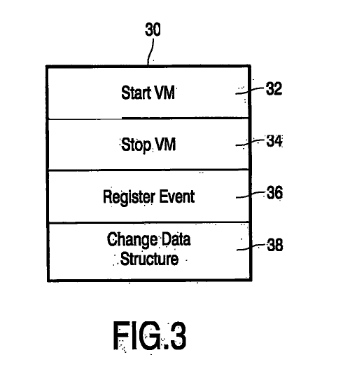

FIG. 3 is a schematic of an API implementing the invention.

A DVD video player 2 according to a first embodiment of the invention includes a DVD reader 4 for reading a DVD disk 6 inserted into the player 2. The DVD video player 2 also includes a processor 10 and memory 12. The DVD video player may also have a number of other components, such as a remote control 14 in the case of a stand alone player. If the DVD video player 2 is instead implemented on a conventional personal computer, the remote control 14 may be replaced by a keyboard and a mouse or an alternative data input system as is well known.

The DVD video player 2 is connected to an audiovisual reproduction system 16 such as a conventional television. As will be well appreciated by those skilled in the art, the audiovisual reproduction system may be much more complex than a simple television and include surround sound decoders, multichannel amplifiers and many other types of component.

The memory 12 includes code 18 for implementing a platform independent virtual machine in the DVD player 2. By a “virtual machine” is meant a system capable of implementing standard instructions, to allow programs to be implemented in a platform-independent manner. In the specific example now described the virtual machine is a Java virtual machine 18 which allows the DVD video player to execute Java code. However, as the skilled person will appreciate, other platform independent codes exist, for example MHEG, OpenTV, MediaHighway and many more, and these may alternatively or additionally be used.

The memory 12 also includes code 20 implementing a DVD-V virtual machine. Much of the functionality of this is standard and allows the DVD video player 2 to simply play back audiovisual DVD video content, access menus using the remote control 14, and carry out all the standard functions of a DVD video player.

In the preferred embodiment, the DVD VM 20 is implemented in the platform independent code 18 of the platform independent virtual machine 18. This makes communication between the DVD VM 20 and external applications running in the platform independent virtual machine 18 straightforward. However, the skilled person will be aware of how to communicate between processes running on different applications in the same DVD player so it is not essential that the DVD VM runs in the same platform independent virtual machine 18.

The DVD VM 20 also includes an application programming interface 30 (API) that gives the DVD video player 2 enhanced functionality.

The API 30 exposes the structure of the DVD-video data and the virtual machine in that calls to the API can be used to access the data, including the cells, the video objects and the various other standard parts of DVD video data. Calls to the API can be used to carry out the following functions illustrated schematically in FIG. 3:

(1) Start the VM 32, i.e. start the decoding of DVD video;

(2) Stop the VM 34;

(3) Register 36 specified events with the VM, for example a particular position in the DVD-video data, such as a particular cell being reached or a particular option being selected in a particular menu; and

(4) manipulate data structures 38, for example to change the menus to be displayed by the VM.

The API provides capabilities to register callbacks from the DVD VM which are called when the specified events occur. In general, these will be the events previously registered by a call to the API, but other events may also cause a call back, for example reaching the end of the DVD video data.

A DVD 6 with enhanced functionality is illustrated schematically in FIG. 2.

The DVD includes DVD video data 22 and additionally a Java archive file (.jar file) 24 with a standard name, for example start.jar, stored in the UDF/ISO file system of the DVD. The archive file stores a number of files including a manifest file 26, as is conventional in Java archives, called META_INF/MANIFEST.MF, as well as an autostart application file 29. This is extended to include a representation of an Application Information Table (AIT) 28 as used in MHP broadcast environments to signal an MHP application. The AIT identifies the main external application 27 and starting parameters.

On inserting the DVD disk 6 the Java archive file 24 is decompressed and the manifest used to run the autostart application 29 with suitable parameters. Assuming the autostart application 29 is written in Java, this autostart application 29 will be run on the java virtual machine 18 in the DVD video player 2.

The autostart application 29 calls the DVD video API to register events, After registering events, the autostart application 29 then calls the DVD video API to start the DVD VM 20 playing back the DVD video data 22. When the DVD VM 20 passes one of the registered events, control is passed back from the DVD VM 20 to the autostart application 29 to allow the autostart application 29 to process the event.

Different events will require different processing and the approach described is intended to be flexible and to allow different content to be provided. The API 30 allows calls to be made to the DVD VM to update the menu structures, and this may be all that is required for some events. Alternatively, for other events complex interactive programs may be started and run by the autostart application 29, for example a computer game application 27. In some cases, it will be desired to stop the DVD VM, and this can be carried out by a suitable call to the DVD VM API from the autostart application 29. In other cases, it is desired that the DVD VM simply carries on.

In this specification, applications such as the autostart application 29 and other applications 27 running externally of the DVD VM will be known as external applications 27,29.

In some cases, a menu item may be added by an external application 27,29 in response to one event and the selection of this menu item registered as an event, and processing passed back to the DVD VM. Then, if the menu is reached and the item selected, the application can carry out suitable action, for example stopping the DVD video playback and starting a game.

After processing the event, control may pass back using the DVD video API to the DVD VM to allow continued DVD video playback.

Thus, this approach allows a DVD disk 6 to autostart, using the autostart application 29 in a suitable player 2. If, however, the DVD disk 6 is inserted in a conventional player, the conventional DVD VM in that player will start and the DVD disk 6 will play as normal, although without the additional functionality provided by the event handling in the external applications 27, 29 or called by these applications.

An alternative approach to provide suitable autostart functionality may be provided in which the Java archive file 24 is stored in an extra elementary stream provided on the DVD disk. For example, the archive file may be provided in a stream with a stream type of 0x06 representing private data or a stream type in the user data range 0x80 to 0xFF, for example 0xBS or 0xBF. The archive file is divided into packets, the first packet containing the AIT data.

On inserting a DVD disk 6 into a DVD player 2, the boot loader identifies the extra elementary stream and checks whether the first packet contains an AIT. If so, it builds a jar file from the stream, adds that file to the path and starts the application specified in the AIT.

Normal DVD players would simply ignore the extra stream.

This alternative approach has the significant benefit that the external applications 27,29 may be protected by the DVD scrambling system.

MPEG stream descriptors may be included in the DVD video stream to allow external applications to synchronise with events in the DVD video. For example, a mechanism to support this could consist of placing a digital storage media-command and control (DSMCC) StreamEvent object in the file system visible to the external application. In the case of an MHP application, it would use the org.dvb.dsmcc API to register a callback on the DSMCC StreamEvent object. This causes the system to start monitoring the DVD video stream for certain stream descriptors. Callbacks occur when the descriptors are decoded. Note that this mechanism requires more than just mounting the UDF filesystem on the DVD—either an emulation layer on top of UDF, or a decoder for a DSMCC filesystem stored separately on disc would be needed.

It is also worth noting that the DVD video file system is exposed through the API and this allows excellent integration of the external application into the DVD video.

Control of the DVD VM from the external application may also be provided through the Java media framework (JMF).

Although the autostart application 29 has been described as a Java application, there are many other platform independent standards, such as MHEG, openTV, MediaHighway, and the autostart application may be written, at least in part, in one or more of these. In certain cases, for example when it is known what kind of player 2 the DVD disk 6 is to be run on, non-platform independent code may be provided; alternatively, such non-platform independent code may be used to implement additional functionality on some types of machine.

The invention may be applied to any suitable player.

From reading the present disclosure, other variations and modifications will be apparent to persons skilled in the art. Such variations and modifications may involve equivalent and other features which are already known in the design, manufacture and use of DVD and which may be used in addition to or instead of features described herein. Although claims have been formulated in this application to particular combinations of features, it should be understood that the scope of disclosure also includes any novel feature or any novel combination of features disclosed herein either explicitly or implicitly or any generalisation thereof, whether or not it mitigates any or all of the same technical problems as does the present invention. The applicants hereby give notice that new claims may be formulated to any such features and/or combinations of such features during the prosecution of the present application or of any further applications derived therefrom.

1. A DVD disk (6), including
content (22) stored in a DVD-video format including audiovisual content and at least one menu;
application code (28, 29) in a non-DVD-video platform independent format; and
means stored on the disk for identifying events that occur during playback of the content stored in DVD-video format for triggering an enhanced DVD player to run application code corresponding to the triggered event.

2. A method of displaying audiovisual content stored on a disk including DVD-video content and non-DVD video application content, including the steps of:
running an external application (28) stored on the disk;
starting a DVD video virtual machine (VM) (20) for running DVD-video content including audiovisual content and DVD-video menus;
in the DVD video VM (20), reading the DVD video content from the disk and providing an audiovisual display based on that content;
determining when specified events occur in the DVD video VM and calling back from the DVD video VM to the external application (28) when one or more of the specified events occur; and
executing application commands (28, 29) triggered by the event that has occurred.

3. A method according to claim 2, further comprising starting a platform independent execution environment (18), and running the external application (28) in that environment.

4. A method according to claim 3, including inserting the disk (6) into a suitable player and autostarting the platform-independent execution environment (18).

5. A method according to claim 3, wherein the DVD VM includes an application programming interface API for control from the platform-independent execution environment, the method including the step of calling the API from the platform-independent execution environment to register the specified events with the API, and calling back from the video VM to the platform-independent execution environment when the registered specified events occur.

6. A method according to claim 2 including the step of calling the API to manipulate video VM data structures from the external application (28).

7. A method according to claim 6 wherein the video VM data structures are menus.

8. A method according to claim 2 including recognising an MPEG stream descriptor stored on the DVD identifying DVD-video content to trigger a determination in the DVD video VM of a specified event occurring.

9. A DVD player comprising:
a DVD virtual machine (VM) (20) for displaying DVD-video data, the DVD virtual machine (20) further including an application programming interface (API) (30) containing code whereby external applications can call the API to start or stop execution of the DVD VM, to register specified events, and to call a calling application back when specified events occur;
an autostart system for automatically running an external application (28) stored on an inserted DVD disk, if the external application is present, so that the external application (28) calls the DVD VM API (20) to play back content on the DVD.

10. A DVD player according to claim 9 wherein the DVD VM API also implements calling the API to manipulate DVD data structures.

11. A computer program for causing a DVD player to carry out the steps of a method according to claim 2.

12. A computer program according to claim 11 recorded on a data carrier.
